(19) United States
(12) Patent Application Publication
(10) Pub. No.: US 2007/0024535 A1
(43) Pub. Date: Feb. 1, 2007

(54) DRIVING METHOD OF PLASMA DISPLAY APPARATUS

(75) Inventors: Changyoung KWON, Pohang-si, Gyeongsangbuk-do (KR); Yun Kwon JUNG, Gumi-si, Gyeongsangbuk-do (KR); Byung Hyun KIM, Gumi-si, Gyeongsangbuk-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/420,162

(22) Filed: May 24, 2006

(30) Foreign Application Priority Data
Jul. 30, 2005 (KR) 10-2005-0070070

(51) Int. Cl. G09G 3/28

(52) U.S. Cl. 345/67

(57) ABSTRACT

A plasma display apparatus, which is advantageous of reducing abnormal discharge, improving a darkroom contrast characteristic and increasing an operation margin, and a driving method thereof are provided. In an embodiment, a driving method of a plasma display apparatus comprising a first electrode and a second electrode includes a first step for applying a positive polarity direction voltage to the second electrode before a reset period, and a second step for applying at least two reset signals to the first electrode.

This non-provisional application claims priority under 35 U.S.C. § 119(a) on Patent Application No.10-2005-0070070 filed in Korea on Jul. 30, 2005, the entire contents of which are hereby incorporated by reference.

### BACKGROUND OF THE INVENTION

1. Field of the Invention

The present invention relates to a plasma display apparatus, and more particularly, to a plasma display apparatus, advantageous of reducing abnormal discharge, improving a darkroom contrast characteristic and increasing an operation margin, and a driving method thereof.

2. Description of the Background Art

In general, a plasma display apparatus displays an image when phosphors emit light due to ultraviolet light that is generated when an inert gas mixture such as helium (He) and xenon (Xe), neon (Ne) and Xe, or He, Xe and Ne is discharged. Such a plasma display apparatus can be easily implemented with a large screen, and a current technological advancement allows an improvement on image quality.

To implement a gray scale of an image, a plasma display apparatus drives on a time divisional basis by which one frame is divided into several subfields having different emitting numbers. Each of the subfields is divided into three parts comprising a reset period, an address period and a sustain period. The reset period is to initialize discharge cells, the address period is to select a discharge cell, and the sustain period is to implement a gray scale according to the number of discharge.

A typical plasma display apparatus may have a limitation in that initialization discharge does not occur smoothly during a reset period of an nth subfield since a large amount of wall charge is eliminated during an elimination period of an (n−1)th subfield.

When an exceeding amount of negative charge remains over scan electrodes prior to the reset period of the nth subfield, dark discharge often does not take place during a set up period. Thus, discharge cells are not likely to be initialized. When a voltage of a positive signal is increased to instigate stable initialization discharge even though negative charge remains exceedingly over the scan electrodes, power consumption may increase, and strong discharge may be induced during the reset period, thereby degrading a darkroom contrast characteristic.

When an exceeding amount of positive charge remains over the scan electrodes prior to the reset period of the nth subfield, strong discharge occurs during the set up period instead of dark discharge. Thus, a normal initialization operation often does not occur, resulting in a degraded darkroom contrast characteristic.

If dark discharge does not occur during the set up period, abnormal discharge or erroneous discharge may take place in the discharge cells during the address period or the sustain period after the address period.

### SUMMARY OF THE INVENTION

Accordingly, an object of the present invention is to solve at least the problems and disadvantages of the background art.

According to an exemplary embodiment of the present invention, a method of driving a plasma display apparatus comprising a first electrode and a second electrode comprises a first step for applying a positive polarity direction voltage to the second electrode before a reset period, and a second step for applying at least two reset signals to the first electrode.

According to another exemplary embodiment of the present invention, a plasma display apparatus comprises a plasma display panel comprising a first electrode and a second electrode for forming a pair of electrodes, a first driver supplying at least two reset signals that comprise a first set up signal, a first set down signal, a second set up signal, and a second set down signal to the first electrode, and a second driver supplying a positive polarity direction voltage before a reset period, and supplying a first Z negative signal that gradually goes down corresponding to the first set down signal and supplying a second Z negative signal that gradually goes down corresponding to the second set down signal to the second electrode.

According to a further exemplary embodiment of the present invention, a plasma display apparatus comprises a plasma display panel comprising a first electrode and a second electrode for forming a pair of electrodes, a first driver supplying a first Y negative signal that gradually goes down before a reset period, supplying at least two reset signals that comprise a first set up signal, a first set down signal, a second set up signal, and a second set down signal to the first electrode, and a second driver supplying a positive polarity direction voltage before a reset period, and supplying a first Z negative signal that gradually goes down corresponding to the first set down signal and supplying a second Z negative signal that gradually goes down corresponding to the second set down signal to the second electrode.

### BRIEF DESCRIPTION OF THE DRAWINGS

The invention will be described in detail with reference to the following drawings in which like numerals refer to like elements.

FIG. 1 is a diagram illustrating a subfield pattern to implement 256 gray scales in a plasma display apparatus in accordance with an embodiment of the present invention;

FIG. 2 is a simplified top view illustrating an arrangement of electrodes of a three-electrode alternating current (AC) surface-discharge type plasma display panel in accordance with an embodiment of the present invention;

FIG. 3 is a driving waveform view obtained when a driving method of a plasma display apparatus is performed in accordance with an embodiment of the present invention;

FIGS. 4a to 4e are diagrams illustrating sequential distributions of wall charge within discharge cells changing according the driving waveform illustrated in FIG. 3;

FIG. 5 is a driving waveform view obtained when a driving method of a plasma display apparatus is performed in accordance with another embodiment of the present invention; and

FIG. 6 is a block diagram illustrating a plasma display apparatus in accordance with an embodiment of the present invention.

### DETAILED DESCRIPTION OF PREFERRED EMBODIMENTS

Preferred embodiments of the present invention will be described in a more detailed manner with reference to the drawings.

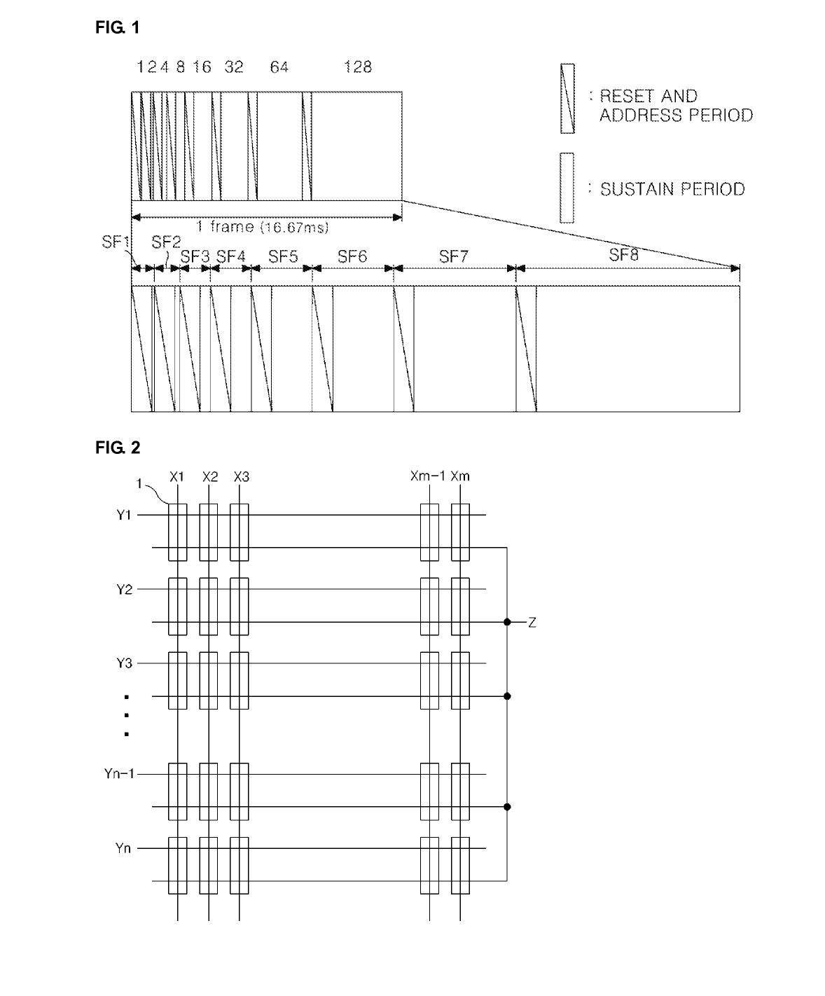

FIG. 1 is a diagram illustrating a subfield pattern to implement 256 gray scales in a plasma display apparatus in accordance with an embodiment of the present invention.

As illustrated in FIG. 1, when an image is displayed in 256 gray scales, a frame period corresponding to 1/60 seconds, i.e., 16.67 ms, is divided into eight subfields SF1 to SF8. Each of the eight subfields SF1 to SF8 is divided into a reset period, an address period and a sustain period. The reset period and the address period of each subfield are identical to each other. However, the sustain period of each subfield and the number of sustain pulses assigned thereto increase by a factor of 2ⁿ, where n=0, 1, 2, 3, 4, 5, 6, and 7.

FIG. 2 is a simplified top view illustrating an arrangement of electrodes of a three-electrode AC surface-discharge type plasma display panel in accordance with an embodiment of the present invention.

As illustrated in FIG. 2, the three-surface AC surface-discharge type plasma display panel comprises scan electrodes Y1 to Yn and sustain electrodes Z both formed over a first substrate, and address electrodes X1 and Xm formed over a second substrate perpendicular to the scan electrodes Y1 to Yn and the sustain electrodes Z.

Discharge cells 1 are arranged in a matrix pattern at those points where the scan electrodes Y1 to Yn and the sustain electrodes Z intersect with the address electrodes X1 to Xm to display one of red, green and blue colors. Although not illustrated, a dielectric layer and a magnesium oxide (MgO) layer, which serves as a protection layer, are formed over the first substrate where the scan electrodes Y1 to Yn and the sustain electrodes Z are formed.

Over the second substrate where the address electrodes X1 to Xm are formed, barrier ribs are formed between the adjacent discharge cells 1 to prevent optical and/or electrical interference. Phosphors are formed over the second substrate and the surface of the barrier ribs. The phosphors are excited by ultraviolet light to emit visible light. An inert gas mixture, e.g., He and Xe, Ne and Xe, or He, Xe and Ne, is injected into a discharge space between the first substrate and a second substrate.

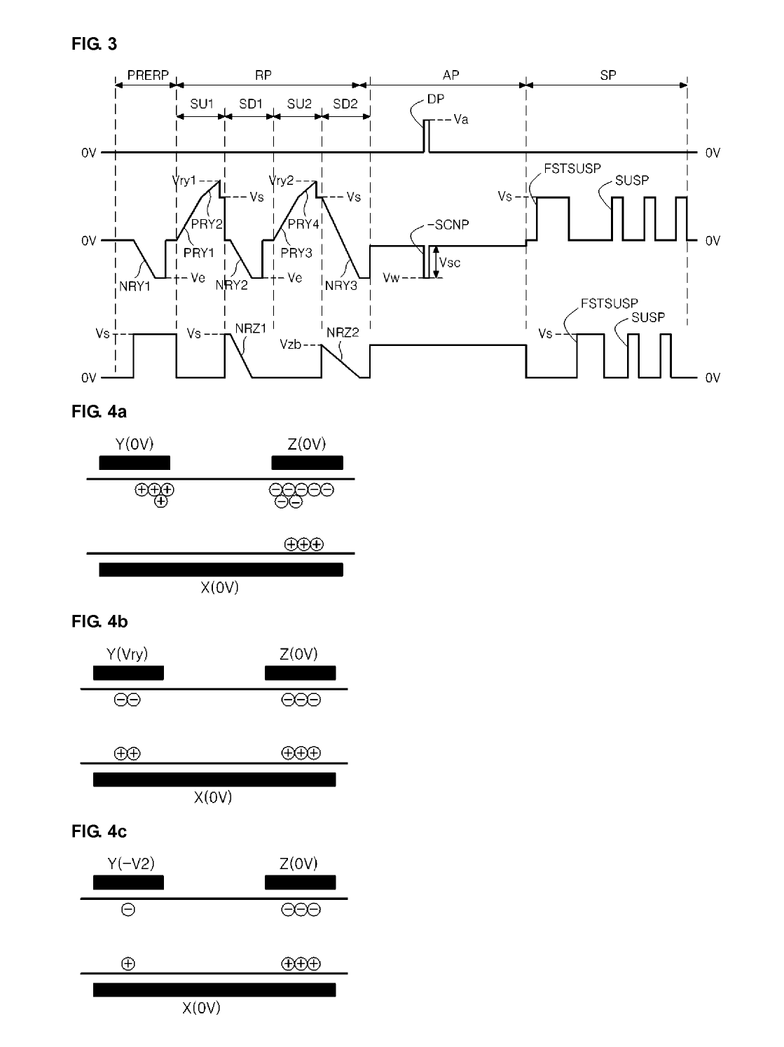

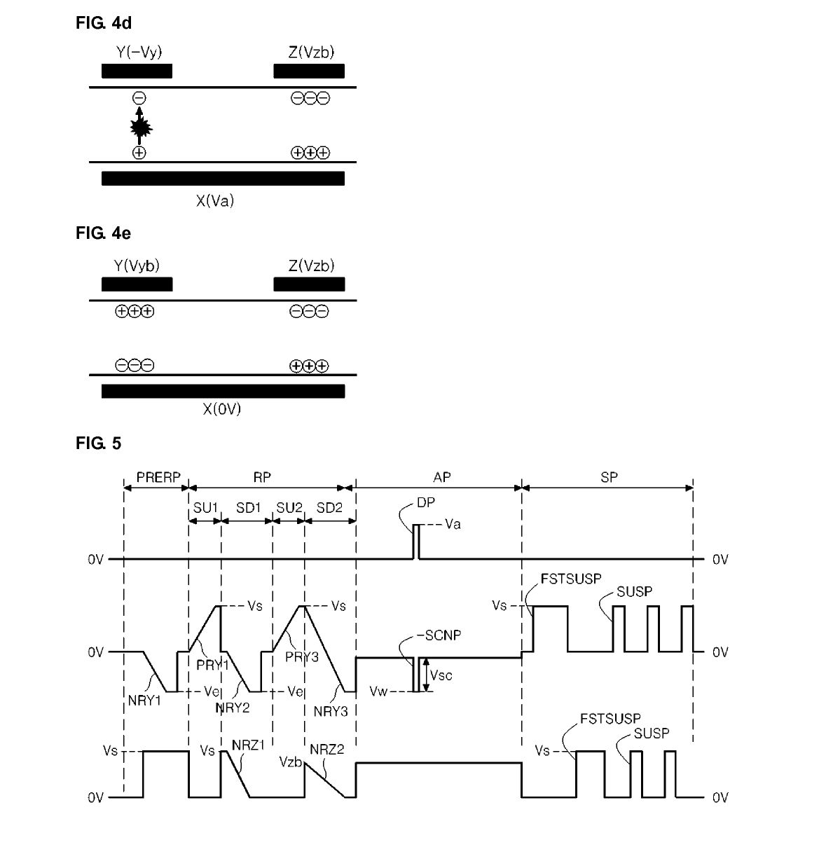

FIG. 3 is a driving waveform view obtained when a driving method of a plasma display apparatus is performed in accordance with an embodiment of the present invention. FIGS. 4a to 4e are diagrams illustrating sequential distributions of wall charge within discharge cells changing according to the driving waveform illustrated in FIG. 3.

Referring to FIG. 3 and FIGS. 4a to 4e, the driving method of the plasma display apparatus comprises a pre-reset period PRERP, a reset period RP, an address period AP, and a sustain period SP. The pre-reset period PRERP is to generate positive wall charges over scan electrodes Y and negative wall charges over sustain electrodes Z. The reset period RP is to initialize discharge cells using a wall charge distribution obtained during the pre-reset period PRERP. The address period AP is to select certain discharge cells, and the sustain period SP is to sustain a discharge state of the selected discharge cells.

During the pre-reset period PRERP, a positive polarity direction sustain voltage Vs is applied to the sustain electrodes Z, and a first Y negative signal NRY1 that gradually goes down from approximately 0 V or a ground level voltage GND to a negative polarity direction elimination voltage −Ve is applied to the scan electrodes Y.

During the pre-reset period PRERP, the address electrodes X are applied with approximately 0 V. The positive polarity direction sustain voltage Vs, applied to the sustain electrodes Z, and the first Y negative signal NRY1 cause dark discharge to occur in all of the discharge cells disposed between the scan electrodes Y and the sustain electrodes Z and between the sustain electrodes Z and the address electrodes X.

As a result of this dark discharge, as illustrated in FIG. 4a, after the pre-reset period PRERP, a large amount of positive wall charge is accumulated over the scan electrodes Y, while a large amount of negative wall charge is accumulated over the sustain electrodes Z within the entire discharge cells. Positive wall charge is accumulated over the address electrodes X.

Due to the wall charge distribution illustrated in FIG. 4a, a large positive gap voltage is generated inside the inner discharge gas spaces of the entire discharge cells disposed between the scan electrodes Y and the sustain electrodes Z, and an electric field is created from the scan electrodes Y to the sustain electrodes Z within the individual discharge cells.

Although it is illustrated in FIG. 3 that the pre-reset period PRERP exists before the reset period RP, the pre-reset period PRERP may not exist in all subfields but in at least one subfield. In another embodiment of the present invention, the pre-reset period may not even exist.

The reset period RP comprises a first set up period SU1, a first set down period SD1, a second set up period SU2, and a second set down period SD2 to induce two times of set up discharge and two times of set down discharge to occur within the discharge cells. As a result, an initial addressing condition can be optimized.

During the first set up period SU1, a first Y positive signal PRY1 and a second Y positive signal PRY2 are applied to the scan electrodes Y, and the sustain electrodes Z and the address electrodes X are applied with approximately 0 V. A voltage of the first Y positive signal PRY1 goes up from approximately 0 V to the positive polarity direction sustain voltage Vs. A voltage of the second Y positive signal PRY2 goes up from the positive polarity direction sustain voltage Vs to a positive polarity direction Y reset voltage Vry1 higher than the positive polarity direction sustain voltage Vs. A slope of the second Y positive signal PRY2 is lower than the slope of the first Y positive signal PRY1. In another embodiment of the present invention, the slope of the second Y positive signal PRY2 may be substantially identical to the slope of the first Y positive signal PRY1.

As the first Y positive signal PRY1 and the electric field created between the scan electrodes Y and the sustain electrodes Z within the discharge cells are added together, dark discharge occur in all of the discharge cells between the scan electrodes Y and the sustain electrodes Z and between the scan electrodes Y and the address electrodes X.

As a result of this dark discharge, as illustrated in FIG. 4b, after the first set up period SU1, negative wall charge is accumulated over the scan electrodes Y inside the discharge cells, causing the polarity direction of the scan electrodes Y to be inversed from positive to negative. Positive wall charge is accumulated over the address electrodes X. Also, wall charge accumulated over the sustain electrodes Z sustain the negative polarity although an amount of wall charge of the sustain electrodes Z decreases as some of the wall charge moves to the scan electrodes Y.

Due to the wall charge distribution obtained after the pre-reset period PRERP, the positive polarity direction Y reset voltage Vry1 in the first set up period SU1 can be lowered to an intended level since the positive gap voltage is large within all of the discharge cells before the dark discharge takes place during the first set up period SU1.

An experimental result, in which the wall charge distribution of the entire discharge cells was initialized as illustrated in FIG. 4a before the set up discharge, verifies that the set up discharge could occur in all of the discharge cells at a voltage lower than the positive polarity direction sustain voltage Vs. Thus, in the driving waveform illustrated in FIG. 3, the second Y positive signal PRY2 may be unnecessary, and the voltage applied to the scan electrodes Y during the first set up period SU1 can stimulate stable set up discharge in all of the discharge cells even though the first Y positive signal PRY1 makes the voltage increase up to the positive polarity direction sustain voltage Vs.

After the pre-reset period PRERP and the first set up period SU1, a large amount of positive wall charge is accumulated over the address electrodes X. Thus, an externally applied voltage necessary for address discharge, i.e., absolute values of a data voltage and a scan voltage, can be lowered.

During a first set down period SD1 after the first set up period SU1, a second Y negative signal NRY2 is applied to the scan electrodes Y, and at the same time, a first Z negative signal NRZ1 to the sustain electrodes Z. A voltage of the second Y negative signal NRY2 goes down from approximately 0 V or the ground level voltage to the negative polarity direction elimination voltage −Ve.

A voltage of the first Z negative signal NRZ1 goes down from the positive polarity direction sustain voltage Vs to approximately 0 V or the ground level voltage. During the first set down period SD1, the voltages of the scan electrodes Y and the sustain electrodes Z are lowered simultaneously. As a result, discharge does not take place between the scan electrodes Y and the sustain electrodes Z, however, dark discharge takes place between the scan electrodes Y and the address electrodes X.

The first set down discharge take places not by surface discharge between the scan electrodes Y and the sustain electrodes Z accompanying lots of emission of visible light that can be observed by eyes but by opposed discharge between the scan electrodes Y and the address electrodes X accompanying emission of light that cannot be sensed by eyes.

Due to the first set down discharge, an exceeding amount of wall charge is eliminated among the negative wall charge accumulated over the scan electrodes Y, and an exceeding amount of wall charge is eliminated among the positive wall charge accumulated over the address electrodes X. As a result, the discharge cells have a wall charge distribution as illustrated in FIG. 4c.

As similar to the first set up period SU1, during a second set up period SU2, a third Y positive signal PRY3 and a fourth Y positive signal PRY4 are consecutively applied to the scan electrodes Y, and a voltage of approximately 0 V is applied to the sustain electrodes Z and the address electrodes X. The third Y positive signal PRY3 causes a voltage of the scan electrodes Y to increase, and thus, dark discharge takes place between the scan electrodes Y and the sustain electrodes Z and between the scan electrodes Y and the address electrodes X.

As a result of this dark discharge, after the second set up period SU2, negative wall charge is accumulated with an increased amount over the scan electrodes Y, while positive wall charge is accumulated with an increased amount over the address electrodes X. The wall charge accumulated over the sustain electrodes Z moves to the scan electrodes Y, and thus, an amount of the negative wall charge is decreased.

The positive polarity direction set up voltage Vry1 in the first set up period SU1 may be substantially the same as or larger than a set up voltage Vry2 in the second set up period SU2. Also, the slope of the set up pulse in the first set up period SU1 may be substantially the same as the slope of the set up pulse in the second set up period SU2.

During a second set down period SD2, a third Y negative signal NRY3 is applied to the scan electrodes Y, and at the same time, a second Z negative signal NRZ2 to the sustain electrodes Z. A voltage of the third Y negative signal NRY3 goes down from the positive polarity direction sustain voltage Vs to the negative polarity direction elimination voltage −Ve.

A voltage of the second Z negative signal NRZ2 goes down from the positive polarity direction sustain voltage Vs to approximately 0 V or the ground level voltage. During the second set down period SD2, since the voltages of the scan electrodes Y and the sustain electrodes Z are decreased simultaneously, discharge does not take place between the scan electrodes Y and the sustain electrodes Z, but dark discharge take place between the scan electrodes Y and the address electrodes X. The second set down discharge takes place by opposed discharge between the scan electrodes Y and the address electrodes X.

Due to the second set down discharge, an exceeding amount of wall charges among the negative wall charges accumulated over the scan electrodes Y is eliminated, and an exceeding amount of wall charges among the positive wall charges accumulated over the address electrodes X is eliminated. As a result, the discharge cells have a uniform wall charge distribution optimized to the addressing condition.

The set down pulse of the second set down period SD2 may have a slope different from the set down pulse of the first set down period SD1. Particularly, the slope of the set down pulse of the second set down period SD2 may be lower than the slope of the set down pulse of the first set down period SD1.

During the address period AP, a negative polarity direction scan pulse −SCNP is sequentially applied to the scan electrodes Y, and at the same time, a positive polarity direction data pulse DP is applied to the address electrodes X as being synchronized with the negative polarity direction scan pulse −SCNP. A voltage of the negative polarity direction scan pulse −SCNP is a scan voltage Vsc that goes down from approximately 0 V or a negative polarity direction scan bias voltage close to approximately 0 V to a negative polarity direction scan voltage −Vw.

A voltage of the data pulse DP is a positive polarity direction data voltage Va. During the address period AP, a positive polarity direction Z bias voltage lower than the positive polarity direction sustain voltage Vs is supplied to the sustain electrodes Z.

After the reset period RP, address discharge occurs only between the scan electrodes Y and the address electrodes X as the gap voltage between the scan electrodes Y and the address electrodes X exceeds a discharge firing voltage Vf within on-cells to which the scan voltage Vsc and the data voltage Va are applied in the state that the entire discharge cells have the gap voltage adjusted to an optimum condition.

FIG. 4d illustrates a wall charge distribution of the on-cells in which the address discharge occurs. After the address discharge, due to the address discharge, positive wall charge and negative wall charge are accumulated over the scan electrodes Y and the address electrodes X, respectively. As a result, the wall charge distribution within the on-cells is changed to a wall charge distribution illustrated in FIG. 4e.

When the address discharge occurs, as illustrated in FIG. 4d, the discharge occurs only between the scan electrodes Y and the address electrodes X, and thus, a period for the address discharge becomes shortened.

Off-cells in which the address electrodes X are applied with approximately 0 V or the ground level voltage, or the scan electrodes Y are applied with approximately 0 V or the scan bias voltage Vsc have a gap voltage lower than the discharge firing voltage Vf. Therefore, the off-cells without the address discharge substantially retain the wall charge distribution illustrated in FIG. 4c.

During the sustain period SP, sustain pulses FSTSUSP, SUSP and LSTSUSP of the positive polarity direction sustain voltage Vs are alternately applied to the scan electrodes Y and the sustain electrodes Z. During the sustain period SP, the address electrodes Y are applied with approximately 0 V or the ground level voltage. The sustain pulse FSTSUSP first applied to the scan electrodes Y and the sustain electrodes Z has a width larger than the width of the regular sustain pulse SUSP to stabilize the instigation of sustain discharge.

The sustain pulse LSTSUSP is applied last to the sustain electrodes Z. Particularly, the last sustain pulse LSTSUSP has a width larger than the width of the regular sustain pulse SUSP to make negative wall charge be accumulated over the sustain electrodes Z in an initial stage of the set up period SU (i.e., the first set up period SU1 and the second set up period SU2).

During this sustain period, with the assistance of the wall charge distribution illustrated in FIG. 4e, sustain discharge occurs in every regular sustain pulse SUSP within the on-cells between the scan electrodes Y and the sustain electrodes Z selected by the address discharge. In contrast, since the off-cells have the initial wall charge distribution of the sustain period SP illustrated in FIG. 4c, the gap voltage of the off-cells is retained lower than the discharge firing voltage Vf even though the sustain pulses FSTSUSP, SUSP and LSTSUSP are applied. As a result, discharge does not occur.

The driving waveform illustrated in FIG. 3 is not limited only to the first subfield but can be applied to several initial subfields including the first subfield, or to the entire subfields included in one frame period.

FIG. 5 is a driving waveform view obtained when a driving method of a plasma display apparatus is performed in accordance with another embodiment of the present invention.

As illustrated in FIG. 5, during a first set up period SU1 and a second set up period SU2, voltages of positive polarity direction signals PRY1 and PRY3 applied to the scan electrodes Y are increased to a sustain voltage. Even if the voltages of the positive polarity direction signals PRY1 and PRY3 are decreased, set up discharge occurs stably in all of the discharge cells due to a pre-reset period PRERP. An address period AP and a sustain period SP are substantially the same as the address period AP and the sustain period SP described in the above embodiment. Thus, detailed description thereof will be omitted.

As described in FIGS. 3 to 5, the waveforms in which the two set up pulses and the two set down pulses are applied during the reset period can be applied to a plurality of subfields. Particularly, the waveforms can be applied to at least one subfield. According to the gray scale of the subfield, the waveforms can be applied selectively to subfields of a low or high gray scale. Also, the waveforms can be applied to above or below a certain temperature according to the temperature at which the plasma display panel driving or the surrounding temperature.

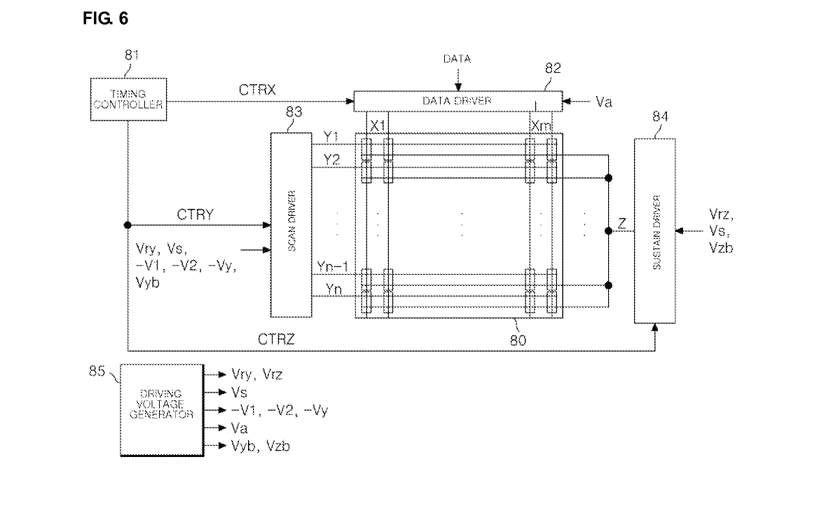

FIG. 6 is a block diagram illustrating a plasma display apparatus in accordance with an embodiment of the present invention.

Referring to FIG. 6, the plasma display apparatus comprises a plasma display panel (PDP) 80, a data driver 82, a scan driver 83, a sustain driver 84, a timing controller 81, and a driving voltage generator 85. The data driver 82 supplies data to address electrodes X1 to Xm of the PDP 80. The scan driver 83 drives scan electrodes Y1 to Yn of the PDP 80. The sustain driver 84 drives sustain electrodes Z of the PDP 80. The timing controller 81 controls the data driver 82, the scan driver 83 and the sustain driver 84, and the driving voltage generator 85 generates driving voltages necessary for the data driver 82, the scan driver 83 and the sustain driver 84.

Using a reverse gamma correction circuit and an error diffusion circuit (not shown), reverse gamma correction and error diffusion operations are applied to the data driver 82. Afterwards, a subfield mapping circuit supplies data mapped to a preset subfield pattern. The data driver 82 applies approximately 0 V or a ground level voltage to the address electrodes X1 to Xm during a pre-reset period PRERP, a reset period RP and a sustain period SP. Also, the data driver 82 samples data under the control of the timing controller 81 and latches the sampled data, and the latched data are supplied to the address electrodes X1 to Xm during an address period AP.

Under the control of the timing controller 81, the scan driver 83 supplies various signals NRY1, PRY1, PRY2, PRY3, and PRY4 to the scan electrodes Y1 to Yn to initialize the entire discharge cells during the pre-reset period PRERP and the reset period RP as illustrated in FIGS. 3 and 5. A scan pulse SCNP is supplied sequentially to the scan electrodes Y1 to Yn to select scan lines to which data are supplied during the address period AP. The scan driver 83 supplies sustain pulses FSTSUSP and SUSP to the scan electrodes Y1 to Yn to allow sustain discharge to occur within on-cells selected during the sustain period SP.

Under the control of the timing controller 81, the sustain driver 84 supplies a square wave of a sustain voltage Vs and negative polarity direction signals NRZ1 and NRZ2 to the sustain electrodes Z to initialize the entire discharge cells during the pre-reset period PRERP and the reset period RP as illustrated in FIGS. 3 and 5. Afterwards, a Z bias voltage is supplied to the sustain electrodes Z during the address period AP. The sustain driver 84 and the scan driver 83 operate alternately during the sustain period SP to supply the sustain pulses FSTSUSP and SUSP to the sustain electrodes Z and the scan electrodes Y1 to Yn.

The timing controller 81 receives horizontal/vertical synchronization signals and a clock signal, generates timing control signals CTRX, CTRY and CTRZ necessary for the data driver 82, the scan driver 83 and the sustain driver 84, and supplies the timing control signals CTRX, CTRY and CTRZ to control the data driver 82, the scan driver 83 and the sustain driver 84.

The timing control signal CTRX supplied to the data driver 82 comprises a sampling clock that samples data, a latch control signal, and a switch control signal to control an on/off time of a driving switching device and an energy recovery circuit.

The timing control signal CTRY supplied to the scan driver 83 comprises a switch control signal to control an on/off time of the driving switching device and an energy recovery circuit.

The timing control signal CTRZ supplied to the sustain driver 84 comprises a switch control signal to control an on/off time of the driving switching device and an energy recovery circuit.

The driving voltage generator 85 generates various driving voltages Vry1, Vry2, Vs, −Ve, −Vw, and Va (refer to FIGS. 3 and 5) supplied to the PDP 80. These driving voltages can vary according to a discharge characteristic changed depending on the resolution of the PDP 80 and a model, or a composition of a discharge gas.

In the embodiments of the present invention, the signals that induce each of write discharge and elimination discharge two times are exemplified. However, the write discharge and the elimination discharge can be induced more than two times by adding the set up period and the set down period according to the resolution of the PDP and the deviation of a driving characteristic.

As described in the exemplary embodiments, the plasma display apparatus is advantageous of reducing abnormal discharge, improving a darkroom contrast characteristic and increasing an operation margin by accumulating a large amount of positive wall charge over the scan electrodes and a large amount of negative wall charge over the sustain electrodes within the discharge cells prior to the reset the discharge cells and then repeating the reset twice.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of driving a plasma display apparatus comprising a first electrode and a second electrode, the method comprising:
a first step for applying a positive polarity direction voltage to the second electrode before a reset period; and
a second step for applying at least two reset signals to the first electrode.

2. The method of claim 1, further comprising a step for applying a first Y negative signal that gradually goes down to the first electrode at the same time of the first step.

3. The method of claim 2, wherein the first Y negative signal goes down from a ground level voltage to a negative polarity direction voltage and the positive polarity direction voltage equals a positive polarity direction sustain voltage.

4. The method of claim 3, wherein the second step is a step for applying a first set up signal, a first set down signal, a second set up signal, and a second set down signal to the first electrode.

5. The method of claim 4, wherein the first set up signal is a first Y positive signal that gradually goes up from a ground level voltage to a positive polarity direction sustain voltage.

6. The method of claim 5, wherein the first set up signal is a second Y positive signal that gradually goes up with a predetermined slope after applying the first Y positive signal.

7. The method of claim 6, wherein the slope of the second Y positive signal is lower than the slope of the first Y positive signal.

8. The method of claim 4, wherein the first set down signal is a second Y negative signal that gradually goes down and at the same time a first Z negative signal that gradually goes down is applied to the second electrode.

9. The method of claim 8, wherein the second Y negative signal goes down from a ground level voltage to a negative polarity direction voltage and the first Z negative signal goes down from a positive polarity direction sustain voltage to a ground level voltage.

10. The method of claim 4, wherein the second set up signal is a third Y positive signal that gradually goes up from a ground level voltage to a positive polarity direction sustain voltage.

11. The method of claim 10, wherein the second set up signal is a fourth Y positive signal that gradually goes up with a predetermined slope after applying the third Y positive signal.

12. The method of claim 11, wherein the slope of the fourth Y positive signal is lower than the slop of the third Y positive signal.

13. The method of claim 4, wherein the second set down signal is a third Y negative signal that gradually goes down and at the same time a second Z negative signal that gradually goes down is applied to the second electrode.

14. The method of claim 13, wherein the third Y negative signal goes down from a positive polarity direction sustain voltage to a negative polarity direction voltage and the second Z negative signal goes down from a positive polarity direction Z bias voltage lower than the positive polarity direction sustain voltage to a ground level voltage.

15. A plasma display apparatus comprising:
a plasma display panel comprising a first electrode and a second electrode for forming a pair of electrodes;
a first driver supplying at least two reset signals that comprise a first set up signal, a first set down signal, a second set up signal, and a second set down signal to the first electrode; and
a second driver supplying a positive polarity direction voltage before a reset period, and supplying a first Z negative signal that gradually goes down corresponding to the first set down signal and supplying a second Z negative signal that gradually goes down corresponding to the second set down signal to the second electrode.

16. The plasma display apparatus of claim 15, wherein the first driver supplies a first Y negative signal that gradually goes down to the first electrode before a reset period.

17. The plasma display apparatus of claim 16, wherein the first set up signal is a first Y positive signal that gradually goes up from a ground level voltage to a positive polarity direction sustain voltage, the first set down signal is a second Y negative signal that gradually goes down from a ground level voltage to a negative polarity direction voltage, the second set up signal is a third Y positive signal that gradually goes up from a ground level voltage to a positive polarity direction sustain voltage, the second set down voltage is a third Y negative signal that gradually goes down from a positive polarity direction sustain voltage to a negative polarity direction voltage.

18. The plasma display apparatus of claim 17, wherein the first Z negative signal gradually goes down from a positive polarity direction sustain voltage to a ground level voltage, the second Z negative signal gradually goes down from a positive polarity direction Z bias voltage lower than the positive polarity direction sustain voltage to a ground level voltage, a width of the positive polarity direction voltage is larger than a width of at least one sustain signal supplied during a sustain period.

19. The plasma display apparatus of claim 18, wherein the first set up signal comprises the first Y positive signal and a second Y positive signal that goes up with a predetermined slope, the second set up signal comprises the third Y positive signal and a fourth Y positive signal that goes up with a predetermined slope.

20. A plasma display apparatus comprising:
a plasma display panel comprising a first electrode and a second electrode for forming a pair of electrodes;
a first driver supplying a first Y negative signal that gradually goes down before a reset period, supplying at least two reset signals that comprise a first set up signal, a first set down signal, a second set up signal, and a second set down signal to the first electrode; and
a second driver supplying a positive polarity direction voltage before a reset period, and supplying a first Z negative signal that gradually goes down corresponding to the first set down signal and supplying a second Z negative signal that gradually goes down corresponding to the second set down signal to the second electrode.
